(19) United States
(12) Patent Application Publication
(10) Pub. No.: US 2008/0047016 A1
(43) Pub. Date: Feb. 21, 2008

(54) CCLIF: A quantified methodology system to assess risk of IT architectures and cyber operations

(75) Inventor: Stephen Spoonamore, Wooster, OH (US)

Correspondence Address: Stephen Spoonamore;Cybrinth, LLC, Suite 300, 1615 L. Street, N.W., Washington, DC, 20036, US

(73) Assignee: Cybrinth, LLC, Washington, DC (US)

(21) Appl. No.: 11/504,716

(22) Filed: Aug. 16, 2006

(51) Int. Cl. G06F 11/00

(52) U.S. Cl. 726/25

(57) ABSTRACT

The Cybrinth Continuous Learning Information Feedback (CCLIF) Process and the corresponding assessment approach, the CCLIF Process Assessment Method (CLIFAM), comprise a new and unique process for formally generating and defining the principles of electronic security (e-security) and evaluating an organization's e-security practices. The CCLIF Process describes the essential characteristics of an organization's e-security processes that must exist to ensure compliance with e-security basic principles and best practices.

The assessment method supports continuous improvement and can be customized through the application of the process questions according to an organization's size, mission, and functions.

### FIELD OF THE INVENTION

The present invention relates to formally generating and defining the principles of electronic security (e-security) and evaluating an organization's e-security practices. The associated assessment method supports continuous improvement and can be customized through the application of the process questions according to an organization's size, mission, and functions.

### BACKGROUND OF THE INVENTION

Digital technology enables the world to become interconnected. Increasingly, an entire economy has become reliant upon a single, network infrastructure. While this offers tremendous opportunities to most industries, it is also a cause for concern as security issues are improperly addressed or neglected. Serious crimes such as theft, fraud, and extortion can occur in great magnitude and instantaneously. The new network-mediated economy paradoxically presents unparalleled opportunities for the creation of good outcomes or the perpetuation of bad ones. Examples of dangerous emerging trends in this area are:
3600% increase in domestic computer crime since 1997 (US-CERT);
FBI Director named Cyber-crime the nations #1 criminal problem (ITAA book “Long Campaign”);
One out of every three home computers is compromised (Earthlink Study 2004);
29.4 million Americans lost their identities over the past two years (FTC);
83% of financial institutions experienced compromised systems/databases in 2003; a statistic that is double that from 2002 (Deloitte Global Security Survey).

In an effort to mitigate these types of threats, the World Bank publication “Electronic Safety and Soundness: Securing Finance in a New Age” describes e-security processes and procedures. As the network infrastructure spans across industry borders, so does the critical need for electronic security. As far back as 1995, the ISO/IEC 13335, better known as the Guidelines for the Management of IT Security (GMITS), recognized that the Internet was a hostile environment that would require the use of proper e-security. Many of the existing security standards and approaches are outdated and insufficient given the growth in outsourcing, wireless usage, applications, blended threats, and the organized and dynamic approach to hacking that various criminal syndicates have taken in recent years. The CCLIF approach incorporates security and data protection processes that all too often have been ignored.

Because more critical and sensitive information is being stored and transmitted using electronic devices such as cellular telephones, Blackberry devices, PCs, laptops, and notebook computers, the security of this data is vitally important. Loss or theft of these items directly affects the confidentiality, integrity, and available of the information they hold. In addition, the continued growth of business to consumer online dealings, including International transactions, has increased the need for protecting these financial transactions. In particular, this security applies to credit card transactions, which are the major mechanism used for online payments. In addition, debit cards and online banking are also being employed to conduct electronic business.

As an example of e-security, credit card companies have implemented a number of measures to protect their transactions. These approaches include SET, MasterCard SecureCode, and Verified by Visa. SET has not being widely accepted, but the SecureCode and Verified by Visa are being applied and utilize user passwords to protect associated transactions. Another anti-fraud method that is being adopted is the one-off credit card number. When a purchase is to be made, software provided by the credit card organization generates a “one-time” credit card number, which is valid for one purchase. After the number is used, it is no longer valid and will be rejected if another individual attempts to use it again.

The growth of e commerce depends on the confidence of customers in the security of their transactions and the protection of their sensitive information. From the point of view of the businesses involved, the growth of the electronic commerce economy depends on keeping transaction costs low while still providing efficient transfers and acceptable risks. Effective security measures do involve additional process costs. In general, the direct cost component of e-commerce payment systems comprise financial service provider fees while indirect costs include opportunity costs, transaction speed and efficiency, transaction complexity, risk, and payment modes.

As important and necessary as these security solution examples are, they can be viewed as one component of an organization's information protection and data management requirements. What is needed is a comprehensive evaluation and analysis to determine if the fundamental information protection and assurance principles are being employed by an organization as effective and repeatable processes. The CCLIF process provides the means for conducting this assessment.

A wide variety of products and services packaged as digital content are now available online and this trend will continue. Mobile devices are increasingly being used for purchasing and data exchange. Larger volumes of sensitive information are being stored, manipulated, and exchanged digitally, thus opening this data to threats of compromise and modification.

The rising trends in cyber-crime are a direct result of three phenomena. First, organized crime has made a business model out of hacking. Second, criminal laws tend to overemphasize the risks in funds transfers rather than to address the current cyber-criminal modus operandi of identity theft, including salami slicing and extortion. Finally, there has been an overemphasis on protecting data in transit rather than in storage. Hackers attack data where it sits for 99.9% of the time, in “clients” (e.g., desktops/PDAs and servers). Hackers target servers, remote users, and hosting companies; all of which assume they are secure because of their usage of robust end-to-end encryption. Over-reliance on silver-bullet solutions has created a panacea for online fraud. Business continuity is a key goal of e-security; and both this and business credibility depend upon data integrity and authentication. Thus, defense in depth, specifically through an implementation of Layered Security, is essential to achieving these goals.

### SUMMARY OF THE INVENTION

The scope of the CCLIF process comprises the following:
Information system and information system security activities
Organizations required or expected to apply the fundamental principles of e-security.

CCLIF is a process to evaluate an organization's e-security and serves as a basis for continuous improvement.

A large number of organizations are involved with storing, handling, and processing sensitive information. These institutions are the targets for the CCLIF process.

The e-security CCLIF process and the CLIFAM are intended to be used as a:
Means for organizations to evaluate their e-security practices
Means for organizations to apply best practices
Means for organizations to apply continuous improvement
Means for acquirers of e-security services to evaluate a provider's capabilities

The following are the benefits of using the CCLIF process:
Reliability: Confidence in applying a proven methodology
Continuity. Past evaluations support future application and continuous improvement.
Repeatability. A standard methodology provides consistent results
Assurance. E-security requirements and performance are verified

Organizations responsible for managing and protecting their critical data can achieve the following benefits:
Reliability from the use of repeatable and consistent processes
The ability to apply the fundamental principles of e-security
The ability to apply metrics to e-security capabilities

Risk management is an essential and critical part of any e-security assessment process. Identifying and managing risks can minimize the potential impact of associated threats on critical information system resources. Thus, risk management should always be a component of the system development life cycle. NIST SP 800-30 defines risk management as having the following principal components:
Risk assessment
Risk mitigation

NIST SP 800-30 also defines risk as “a function of the likelihood of a given threat-source's exercising a particular potential vulnerability, and the resulting impact of that adverse event on the organization.”

For any risk management program to be effective, it must be supported by senior management, the Chief Information Officer (CIO), system owners, information owners, business managers, functional managers, the Information System Security Officer (ISSO), security practitioners, and users.

Risk assessment comprises the following steps:

1. System characterization

2. Threat identification

3. Vulnerability identification

4. Control analysis

5. Likelihood determination

6. Impact analysis

7. Risk determination

8. Control recommendations

9. Results documentation

Because risk can never be completely eliminated, risk mitigation options must consider cost-benefit issues as well as legal and liability issues. Some of the common risk mitigation options are:
Risk transference—transfer risk to other entities such as an insurance company
Risk assumption—acceptance of the risk and continue IT operations
Risk avoidance—eliminate some functions
Risk limitation—implement safeguards to reduce the negative impact of threats realized
Research and development—conduct research on different types of controls and implementation options

The CCLIF Process elements support risk management by seeking evidence of risk assessment and risk mitigation efforts and assurance that associated controls are effective in meeting their designated security tasks.

The layers of e-security comprising the CCLIF process cover both the hardware and software pertaining to network infrastructures.

These process layers comprise a matrix, which manages the externalities associated with open architecture environments.

The Layers of Security of the e-security CCLIF process are summarized in the following list. These Layers of Security and the Security Objectives that define them are described in detail in TABLE 1.
Layer of Security 01—Risk Management
Layer of Security 02—Policy Management
Layer of Security 03—Cyber-Intelligence
Layer of Security 04—Access Controls/Authentication
Layer of Security 05—Firewalls
Layer of Security 06—Active Content Filtering
Layer of Security 07—Intrusion Detection Systems (IDS)
Layer of Security 08—Virus Scanners
Layer of Security 09—Encryption
Layer of Security 10—Vulnerability Testing
Layer of Security 11—Systems Administration
Layer of Security 12—Incident Response Plan
Layer of Security 13—Wireless Security
Layer of Security 14—Certification and Accreditation
Layer of Security 15—Configuration Management
Layer of Security 16—Input/Output
Layer of Security 17—System Maintenance
Layer of Security 18—Documentation

There are various efforts that share goals, approaches, and benefits with the CCLIF process. The following list describes a representative sampling of these efforts as a comparison to the CCLIF process. None of these other efforts comprehensively targets the practice of e-security as developed in the CCLIF. This situation is justification, in part, for a distinct process for e-security.
HIPAA-CMM—Evaluate HIPAA Security, Privacy and Transactions and Code Sets compliance
SSE-CMM—Define, improve, and assess security engineering capability
SEI-CMM for Software—Improve the management of software development
CMMI—Combine existing process improvement models into a single architectural framework
Common Criteria—Improve security by enabling reusable protection profiles for classes of technology
Systems Engineering CMM (EIA731)—Define, improve, and assess systems engineering capability of threats realized
CISSP—Make security professional a recognized discipline
ISO 9001—Improve organizational quality management
NIST SP 800-37—Guide for the Security Certification and Accreditation of Federal Information Systems

An organization can be assessed against a number of CCLIF Layers of Security. The Layers of Security together, however, are intended to cover all Security Objectives for CCLIF compliance and there are many inter-relationships between the Layers of Security. However, many organizations or subunits may not provide all the services and have all the activities associated with the full complement of CCLIF Layers of Electronic Security. Therefore, a subset of the CCLIF Electronic Layers of Security will be selected according to the size of the organization and the services provided.

The e-security CCLIF process provides a standard metric for evaluating an organization's overall strategy and effectiveness in managing and protecting sensitive information in today's e-commerce business environment. The main CCLIF process objectives are to:
Help Clients Get Maximum Value from their Security Investment
Translate Security Investment through Best Practices into Cost Savings, Greater Productivity, and Excellence in Client Service
Help Clients Define Their Data Custody Chain
Ensure Processes are in Place to Protect Sensitive Information in all its Forms and Locations
Quantify and Define Gap Analysis and Risk Assessments of Client Operations
Integrate Data Custody Methodology into All Levels of the Organization, Vendor Chain and Client Base.

The CCLIF process supports institutionalization by providing practices and a path toward quantitative management and continuous improvement. In this way the e-security CCLIF process asserts that organizations need to explicitly support process definition, management, and improvement.

### BRIEF DESCRIPTION OF THE DRAWINGS

The invention is illustrated by way of example and not limitation and the figures of the accompanying drawings in which references denote like or corresponding parts, and in which:

FIG. 1 illustrates Security Objectives comprising a Security Layer

FIG. 2 illustrates a summary chart of performance of Layers of Security

TABLE 1 illustrates the Security Objectives comprising the respective Layers of Electronic Security and corresponding Checklists

### DESCRIPTION OF THE PREFERRED EMBODIMENTS

The e-security CCLIF process is a compilation of the best-known practices focused on e-security requirements. To understand this process, some background in e-security-related legislation is presented.

Recent laws enacted by the U.S. Congress impose considerable privacy and security requirements on health information, financial information, and Government information and systems. They each require an enterprise approach to security, involving the senior management of the organization. Cumulatively, they impact a large portion of private sector systems. The two major laws directly impacting financial sector security programs are:

### 1. Gramm-Leach-Bliley Act (GLBA) and

### 2. Sarbanes-Oxley Act of 2002.

GLBA states that “each financial institution has an affirmative and continuing obligation to respect the privacy of its customers and to protect the security and confidentiality of those customers' nonpublic personal information.” The GLBA definition of “financial institutions” encompasses banks, securities firms, insurance companies, and other companies providing many types of financial products and services to consumers. This includes lending, brokering, or servicing any type of consumer loan; transferring and safeguarding money; preparing individual tax returns; providing financial advice or credit counseling; providing residential real estate settlement services; collecting consumer debts; and other types of financial services. GLBA's definition of financial institutions has even swept up colleges and universities.

Pursuant to the GLBA, the Federal Trade Commission (FTC), Securities and Exchange Commission (SEC), and Federal financial regulatory bodies have issued regulations requiring administrative, technical, and physical safeguards for financial information. The statute specifies that the regulations are intended:
To ensure the security and confidentiality of customer records and information;
To protect against any anticipated threats or hazards to the security or integrity of such records; and
To protect against unauthorized access to or use of such records or information which could result in substantial harm or inconvenience to any customer.

The regulations set forth the required steps that must be taken, but they do not specify what the technical components of a safeguards program must be. For example, the Federal Trade Commission requires that financial institutions under its purview develop a plan in which the institution must: (1) designate one or more employees to coordinate the safeguards, (2) identify and assess the risks to customers' information in each relevant area of the company's operation and evaluate the effectiveness of the current safeguards for controlling these risks, (3) design and implement a safeguards program and regularly monitor and test it, (4) select appropriate service providers and contract with them to implement safeguards, and (5) evaluate and adjust the program in light of relevant circumstances, including changes in the firms business arrangements or operations, or the results of testing and monitoring of safeguards.

Although the Sarbanes-Oxley Act of 20028 does not specify information security measures, it does require officers of public companies to attest to the appropriateness and integrity of the financial data reported in SEC filings and to assess and report on the effectiveness of the internal control structure and procedures for financial reporting. In today's business environment, financial data is digital and processed and stored in a variety of ways. Therefore, the legal requirements of Sarbanes-Oxley are directly dependent upon the integrity of the IT systems processing the data. Although the financial sector is ahead of other industries in this area, overall, there remains a disturbing lack of understanding at the officer and director levels regarding their oversight and governance responsibilities for the security of corporate data, applications, and networks. These responsibilities include:
Regularly assessing information technology (IT) risks to corporate operations and managing identified threats and vulnerabilities;
Establishing corporate policies governing IT usage, cyber-security, and employee conduct;
Incorporating cyber-security best practices and standards into business operations;
Ensuring sufficient funding is allocated to develop and maintain an enterprise security program with adequate internal controls;
Implementing the security program through training and measuring compliance through meaningful metrics; and
Conducting regular reviews and audits of the security program.

The starting point is to determine the responsibility that boards and officers have to protect their digital assets, which includes information, applications, and networks. In the U.S., this responsibility flows from two sources:
Case law surrounding the fiduciary duty of care directors and officers owe their shareholders and the protections afforded by the “Business Judgment Rule;” and
Compliance with statutes, regulations, Executive Orders and Presidential Directives, administrative consent decrees, contractual agreements, and public expectations.

From an international perspective, the Council of Europe Convention on Cyber-crime (CoE Convention) and the European Union's (EU) Council Framework Decision on attacks against information systems both specify administrative, civil, and criminal penalties for cyber-crimes that were made possible due to the lack of supervision or control by someone in a senior management position, such as an officer or director.

Cyber-crime statistics rise annually as do the monetary losses to financial institutions on account of these crimes. In order to reduce the severity of these damages, it is absolutely critical to implement risk-management processes that can be monitored by examiners (auditors), and that impose a minimum standard for dealing with electronic security. We trust that this checklist will establish a methodology to assess the level of security within a particular organization and create a benchmark by which to gauge the level of need for e-security.

As a background to the practice of e-security, it is useful to understand the fundamental privacy principles that have been adopted by governmental and privacy organizations. An organization applying the CCLIF process has to be cognizant of protecting personally identifiable information from compromise. The following are general privacy principles that should be employed:
Notice regarding collection, use and disclosure of personally identifiable information (PII)
Choice to opt out or opt in regarding disclosure of PII to third parties
Access by consumers to their PII to permit review and correction of information
Security to protect PII from unauthorized disclosure
Enforcement of applicable privacy policies and obligations

These principles have been embodied in legislation and rules, examples of which are listed as follows:
The Cable Communications Policy Act provides for discretionary use of PII by cable operators internally, but imposes restrictions on disclosures to third parties.
The Children's Online Privacy Protection Act (COPPA) is aimed at providing protection to children under the age of 13.
Customer Proprietary Network Information Rules apply to telephone companies and restricts their use of customer information both internally and to third parties.
The Electronic Communications Privacy Act protects exchanged information from being intercepted or disclosed by third parties, including law enforcement agencies.
The Financial Services Modernization Act (Gramm-Leach-Bliley) requires financial institutions to provide customers with clear descriptions of the institutions' polices and procedures for protection the PII of customers.
The Telephone Consumer Protection Act restricts communications between companies and consumers, such as in telemarketing
The 1973 U.S Code of Fair Information Practices addresses personal data record keeping and disclosure
The U.S. Patriot Act gives the U.S. government new powers to subpoena electronic records and to monitor Internet traffic.
The European Union (EU) privacy principles, which address personal data collection and disclosure

The CCLIF Process evaluates the degree of effectiveness of an organization's application of fundamental data management and protection principles in the e-commerce environment.

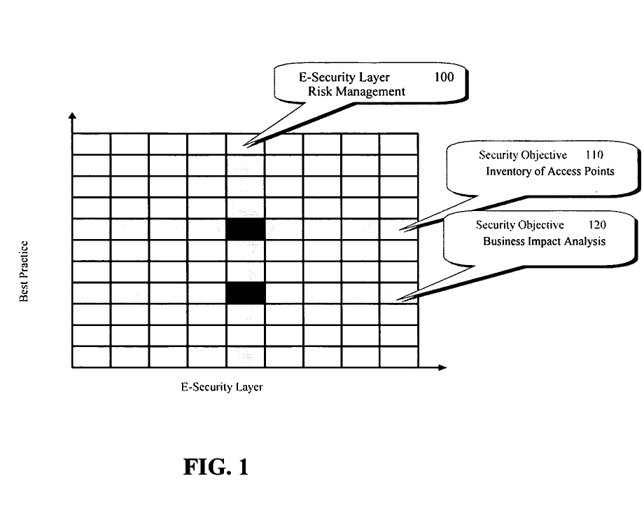

FIG. 1 illustrates a typical process evaluation during a CCLIF appraisal. The evaluation verifies that two of the Security Objectives of Risk Management 100, Inventory of Access Points 110 and a Business Impact Analysis 120 are performed by the appraised entity.

Answering all the Security Objective questions posed by the CCLIF process will provide an effective and repeatable evaluation of an organization's e-security processes.

The e-security CCLIF process is comprised of e-security-specific Security Objectives, organized as Layers of e-Security. The Security Objectives were gathered from a wide range of existing materials, practice, and expertise. The practices selected represent the best existing practices of the e-security community.

A Security Objective:
Applies to all areas of e-security
Is complementary to other e-security objectives
Represents a “best practice” of the e-security community
Can be used in a variety of approaches and environments

The Security Objectives have been organized into Layers of Electronic Security in a way that meets the needs of a broad spectrum of e-security practitioners and consumers. Each Layer of Security has a set of goals that represent the expected state of an organization that is successfully performing the Layers of Security. An organization that performs the Security Objectives of the Layers of Security should also achieve its goals.

A Layer of Electronic Security:
Organizes similar or related Security Objectives under grouped areas
Embodies e-security requirements
Can be implemented in multiple approaches, tailored to an organization
Supports process improvement
Includes all Security Objectives that are required to meet the goals of the Layer of Security

The Security Objectives are considered mandatory items (i.e., they must be successfully implemented to accomplish the purpose of the Layers of Security they support). The general format of the Layers of Security is shown is as follows:

### Layer of Electronic Security—Title

### Electronic Security Heading

### Security Objectives (in question form)

### Questions—Queries to obtain Knowledge Feedback relative to Layer of Electronic Security Heading

### Checklist—Title

### Status—Y(es) or N(o) Response to Security Objective; Target Date of meeting Security Objective

### Comment/Process Evidence—Related Comments and/or Process Evidence of Security Objective Compliance

The following list provides a description of the Electronic Layers of Security. It is important to note that each Layer of Electronic Security comprises a number of Security Objectives. The Security Objectives are considered mandatory items (i.e., they must be successfully implemented to accomplish the purpose of the Layers of Security they support):
1. Risk Management: A broad-based framework for managing relevant risks to enterprise assets and risks to enterprise operations.
2. Policy Management: A program should control policy and procedural guidelines vis-à-vis employee computer usage.
3. Cyber-Intelligence: An experienced threat and technical intelligence analysis regarding threats, vulnerabilities, incidents, and countermeasure should provide timely and customized reporting to prevent a security incident before it occurs.
4. Access Controls/Authentication: Establishment of the legitimacy of a node or user before allowing access to requested information. The first line of defense is access controls; these can be divided into passwords, tokens, biometrics, and public key infrastructure (PKI).
5. Firewalls: Creation of a system or combination of systems that enforces a boundary between two or more networks.
6. Active content filtering: At the browser, gateway, and desktop level, it is prudent to filter all material that is not appropriate for the workplace or that is contrary to established workplace policies.
7. Intrusion detection system (IDS): A system dedicated to the detection of break-ins or break-in attempts, either manually or via software expert systems that operate on logs or other information available on the network. Approaches to monitoring vary widely, depending on the types of attacks that the system is expected to defend against, the origins of the attacks, the types of assets, and the level of concern for various types of threats.
8. Virus scanners: Worms, Trojans, and viruses are methods for deploying an attack. Virus scanners hunt malicious codes, but require frequent updating and monitoring.
9. Encryption: Encryption algorithms are used to protect information while it is in transit or whenever it is exposed to theft of the storage device (e.g., removable backup media or notebook computer).
10. Vulnerability testing: Vulnerability testing entails obtaining knowledge of vulnerabilities that exist on a computer system or network and using that knowledge to gain access to resources on the computer or network while bypassing normal authentication barriers.
11. Systems administration: This should be complete with a list of administrative failures that typically exist within financial institutions and corporations and a list of best practices.
12. Incident response plan (IRP): The primary document used by a corporation to define how it will identify, respond to, correct, and recover from a computer security incident. The main necessity is to have an IRP and to test it periodically.
13. Wireless Security: This section covers the risks associated with GSM, GPS and the 802.11 standards.
14. Certification and accreditation: Certification and accreditation conducted according to standards such as NIST SP 800-37 and the DoD DIACAP are required by governmental organizations and also provide a valuable approach for organizations to ensure that their information systems security is effective and providing the anticipated protections.
15. Configuration management: Configuration management and change control procedures are important elements of an organization's secure posture.
16. Input/Output: Mechanisms to protect, manage, and control I/O products should be up-to-date and in place to protect an organization's sensitive information.
17. System maintenance: Hardware and software maintenance procedures must be in place to support information system security, include application and operations security.
18. Documentation: Policies and procedures must be implemented to ensure that documentation exists and is provided for all hardware and software components of the information system.

In the case of improvement, organizing the Security Objectives into Layers of e-Security provides an organization with an “improvement road map,” should it desire to enhance its capability for a specific process.

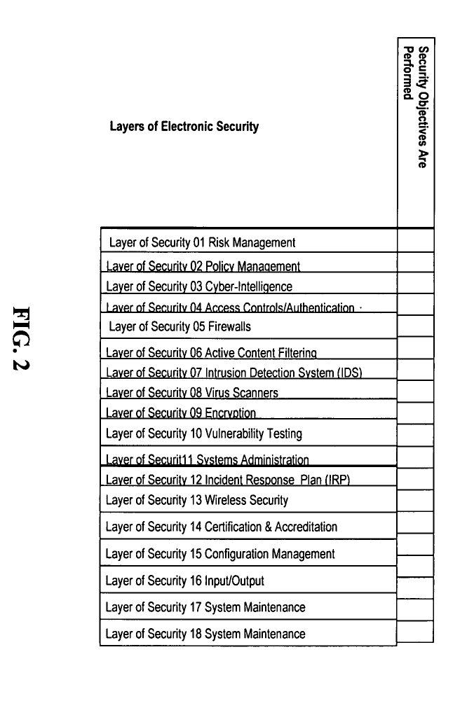

An assessment should be performed to determine the degree of compliance for each of the Layers of Electronic Security. This indicates that different Layers of Electronic Security can and probably will exist at different levels of compliance. The organization will then be able to use this process-specific information as a means to focus on improvements to its processes. FIG. 2 is a summary chart of the Layers of Security that can be used to determine if the Layers are being performed.

Defined goals, business, legal, and regulatory requirements are the primary drivers in interpreting a process such as the CCLIF process.

Each Layer of Electronic Security shown in the chart of FIG. 2 consists of a number of Security Objectives, which are given in TABLE 1.

The CCLIF process is relevant to all groups or organizations that have to ensure that proper management and protections are applied their sensitive information. The process can be applied for evaluating the security posture of an organization and for process improvement. Some questions that need to be answered before the CCLIF is applied are:
How are CCLIF methods practiced by the organization?
How is the organization structured to support CCLIF?
How are support functions handled?
What are the management and practitioner roles used in this organization?
How critical are these processes to organizational success?

Understanding the cultural, business, and legal contexts in which the CCLIF Process will be used is a key to its successful application. This organizational context includes role assignments, organizational structure, and outputs.

The CCLIF Process is structured to support a variety of improvement activities, including self-administered appraisals, or internal appraisals augmented by qualified individuals from inside or outside the organization.

The CCLIF appraisal method is customized to recognize the different organizational needs and to support the evaluation of CCLIF processes within these organizations.

It is not required that any particular appraisal method be used with the CCLIF Process. However, an appraisal method designed to maximize the utility of the e-security process has been designed. This method is the CCLIF Process Appraisal Method (CLIFAM) and it provides the context for how CCLIF should be used in an appraisal.

The CLIFAM is an appraisal method that uses multiple data-gathering methods to obtain information on the processes being practiced within the organization for appraisal. The purposes of a CLIFAM-style appraisal are to:
Obtain a baseline or benchmark of actual practices related to CCLIF processes within the organization
Create and support momentum for improvement within multiple levels of the organizational structure
Ensure that the appraisal is repeatable

Data gathering consists of:
Questionnaires that directly reflect the contents of CCLIF
A series of structured and unstructured interviews with key personnel involved in the performance of the organization's processes
Review of CCLIF practices evidence generated.

Multiple feedback sessions are conducted with the appraisal participants. These sessions are culminated in a briefing to all participants plus the sponsor of the appraisal. The briefing includes results determined for each of the Layers of Security appraised. It also includes a set of prioritized strengths and weaknesses that support process improvement based on the organization's stated appraisal goals.

There are three steps involved in a CLIFAM appraisal. The following list summarizes these steps:
Initiation Phase. The purpose of the Initiation Phase is to define the scope and goals of the evaluation, prepare the appraisal team for the Resident phase, and conduct a preliminary gathering and analysis of data through a questionnaire. The data from the questionnaire is analyzed and supporting evidence is collected. This analysis produces a set of exploratory questions for use in on-site interviews.
Resident Phase. The purpose of the Resident Phase is to explore the results of the preliminary data analysis, and provide an opportunity for practitioners at the appraised entity to participate in on-site data gathering and validation. The relevant organizational practitioners are interviewed and the appraisal results are collated and converted into preliminary results.
Conclusion Phase. The purpose of the Conclusion Phase is to finalize the data analysis developed during the Resident Phase and to present the team findings to the appraisal sponsor.

The first step in assessing an organization is to determine the context within which CCLIF processes are practiced in the organization. The CCLIF Process is intended to be applicable in all contexts. Determination of the context needs to be made in order to decide:
Which Layers of Security are applicable to the organization?
Which personnel are required for the appraisal?
Are the results consistent?

The first step in developing a profile of an organization's capability to perform its CCLIF requirements is to determine whether the basic CCLIF processes (applicable Security Objectives) are implemented within the organization (not just written down) via their performed processes.

The CCLIF Process is designed to measure and help improve an organization's information management and security posture. It should also contribute to an organization's assurance goals.

Four CCLIF Process Goals are important relative the customer's objectives:
Method for organizations to evaluate their CCLIF processes
Method for organizations to define improvements to their CCLIF processes
Means for determining organizations'CCLIF capabilities
Means for acquirers of services to evaluate a provider's CCLIF practices

An organization's CCLIF Process rating stands for the proposition that certain processes were followed throughout the spectrum of CCLIF activities. This “process evidence” can be used to support claims about meeting the CCLIF requirements.

Some types of evidence more clearly establish the claims they support than other types. Frequently, process evidence plays a supporting or indirect role when compared to other types of evidence. It is important to develop a sound rationale that firmly establishes why the system or service satisfies the CCLIF requirements.

The roles of individuals managing and/or responsible for e-security-related domains in an organization should be defined unambiguously. The roles should be specified along with the fundamental skills required for individuals to perform their assigned duties. While there is no standard designation of titles and corresponding roles, some typical usages are given in the following sections.

Government Agencies—Some typical government agency roles are:
Head of Agency—responsible for the organization's information security infrastructure and policy
Senior Agency Officials—provide information system security for the IT systems under the area of responsibility
Chief Information Officer (CIO)— develops and maintains agency-wide information security programs and is the senior IT advisor to the agency head
Senior Information Security Officer—appointed by the CIO and manages information security throughout the agency.
Chief Financial Officer—reports financial management information to OMB and is the senior financial advisor to the head of agency.

Organizations—In an organizational environment, information should be classified for protection and the roles and responsibilities of all participants in the information classification program must be defined. Some typical roles are:
Senior Management—ultimately responsible for exercising due diligence in the protection of the organization's critical information resources
Information Systems Security Officer—delegated the responsibility for information system security by senior management organization's security policy, standards, guidelines, and procedures.
Data Owner—has primary responsibility for determining information classification or sensitivity levels.
Custodian—responsible for protecting sensitive data as delegated by the data owner and administrator of the classification method
User—follows the organization's information system security policy in their use of a sensitive data and protecting that data in the course of their assigned duties.
Information Systems Auditor—conducts regular independent information assurance audits of an organization's information systems and provides reports to senior management.

U.S. Pat. No. 6,988,208 to Habrik, et al. teaches a method and apparatus for verifying the integrity of devices on a target network using secure subsystems to collect and analyze event messages from intrusion detection devices. The method discloses means for self-diagnosing a network in the event of internal or external intruders. This patent differs from the proposed CCLIF approach in that the CCLIF process provides for a comprehensive assessment methodology that can determine the security effectiveness of networks and systems independent of physical devices, which, themselves, are subject to external attack.

U.S. Pat. No. 6,983,221 to Tracy, et al. discloses a method and medium for certifying and accrediting requirements compliance utilizing a risk assessment model. This approach associates one or more data elements with requirements categories and, through a procedure based upon predetermined rules, determines a level of risk of composite data elements as a baseline risk level for each requirements category. This approach focuses generally on the field of certification and accreditation (C&A) and, more particularly, to a computer-implemented system method and medium for C&A. C&A is a specific field that is used to certify that automated information systems, for example, adequately protect information in accordance with data sensitivity and/or classification levels. In accordance with Department of Defense (DoD) Instruction 5200.40, dated Dec. 30, 1997, entitled DoD Information Technology Security Certification and Accreditation Process (DITSCAP). It is based on the very specific characteristics of DITSCAP, which has now been replaced by DIACAP, and is not as comprehensive in its coverage as CCLIF.

U.S. Pat. No. 7,069,437 to Williams discloses a network with various workstations and servers connected by a common medium and through a router to the Internet. The network includes a Network Security Center (NSC) and security network interface cards or devices, which allows trusted users to access outside information, including the Internet, while stopping outside attackers at their point of entry. This patent relates primarily to hardware detection devices and establishes multiple secure Virtual Private Networks (VPNs), all from a single desktop machine. It does not involve an extensive evaluation and breadth of coverage of the CCLIF process methodology.

U.S. Pat. No. 7,076,652 to Ginter, et al. provides systems and methods for secure transaction management and electronic rights protection The present invention incorporates electronic appliances such as computers equipped to ensure that information is accessed and used only in authorized ways. These electronic appliances comprise a distributed virtual distribution environment (VDE) that may enforce a secure chain of handling and control. This approach differs from the CCLIF methodology in that it relies on hardware security devices for specific protections and does not incorporate the wide-ranging detailed security evaluation and correction approach provided by the assessment of all security domains.

U.S. Pat. No. 7,000,247 to Banzhof teaches a system and process for addressing computer security vulnerabilities comprising a remediation server capable of coupling to a security intelligence agent having information about computer vulnerabilities. Then, a remediation signature is constructed and deployed to a client computer. This patent differs from the proposed CCLIF approach in that it is a semi-automated vulnerability analyzer. The CCLIF methodology is a comprehensive assessment, evaluation, and remediation methodology that identifies and defines all relevant information system and e-commerce security processes, covering many domains not considered in a vulnerability analysis.

An e-commerce security assessment methodology comprising Security Objectives and Layers of Security are developed herein as a standard for evaluating the level of e-commerce security and appropriate security controls.

While the preferred embodiment and various alternative embodiments of the invention have been disclosed and described in detail herein, it will be apparent to those skilled in the art that various changes in form and detail may be made therein without departing from the spirit and scope thereof.

TABLE 1

| | | Checklist | | | |
|---|---|---|---|---|---|
| Layers of | | Status | | | |
| Electronic | | | | Target | Comments/Process |
| Security | Security Objectives | Y | N | Date | Evidence |
| | Knowledge Feedback | | | | |
| I. Risk | 1. Does management view e-security as | | | | |
| Management | an overhead expense or essential to | | | | |
| | business survivability? Is this reflected | | | | |
| | in documented policies and day-to-day | | | | |
| | procedures? | | | | |
| | 2. Has the risk management methodology | | | | |
| | been incorporated into corporate | | | | |
| | governance? Is it part of information | | | | |
| | technology rollout? Does senior | | | | |
| | management receive briefings on a | | | | |
| | regular basis on cyber-security issues | | | | |
| | and what proactive steps the company | | | | |
| | is taking to deal with them? | | | | |
| | 3. Does your organization educate and | | | | |
| | train the Board on cyber-risk? How | | | | |
| | often? What percentage of your budget | | | | |
| | is dedicated to education and training | | | | |
| | of the Board? | | | | |
| | 4. How does security and business | | | | |
| | interact in determining cyber-risk and | | | | |
| | security? Are the roles and | | | | |
| | responsibilities of business towards | | | | |
| | security clearly defined? | | | | |
| | 5. Has your company determined | | | | |
| | acceptable levels of cyber-risk as part | | | | |
| | of its overall strategic plan and | | | | |
| | ongoing operational risk and | | | | |
| | forecasted losses? If so, who approves | | | | |
| | this level of risk? | | | | |

| | Organizational Management |
|---|---|
| | 6. Does your organization have a CISO? |
| | Does the CISO report directly to the |
| | CEO? If you do have a CISO, what are |
| | their roles and responsibilities? If you |
| | do not have a CISO who is responsible |
| | for cyber-security and what role does |
| | that person play? |
| | 7. What is the authority of the CISO to |
| | enforce corporate policy and procedure |
| | regarding cyber-risk and security? |
| | 8. Is the security program aligned with |
| | overall business objectives? Is it part |
| | of organizations long term and short |
| | term plans? |
| | 9. Are security considerations a routine |
| | part of normal business processes? |
| | How is this reflected? |
| | 10. Are security considerations included as |
| | a routine part of systems design and |
| | implementation? |
| | 11. Have you developed a protection |
| | strategy and risk mitigation plan to |
| | support the Organization's mission and |
| | priorities? |
| | 12. A risk management framework |
| | requires both an identification and a |
| | prioritization of information assets for |
| | the purpose of determining the level of |
| | security and systems recoverability |
| | appropriate for each asset |
| | classification. Has such an |
| | identification and prioritization of |
| | information assets been performed? |
| | What is included in your company's |
| | definition of information assets? |
| | 13. Does the organization have a |
| | framework in place where they can |
| | adequately measure the success of |
| | security objectives? Has this |
| | benchmark been adequately |
| | communicated throughout the |
| | organization, including partners, |
| | vendors and employees? |
| | 14. How do business units identify, |
| | measure, monitor and control |
| | electronic (“cyber”) security risks |
| | through their technology risk |
| | assessment process and ensure that |
| | adequate safeguarding controls exist |
| | over networks and customer data? |
| | Who monitors this? |
| | 15. Who is responsible for keeping records |
| | of cyber-intrusions, costs of |
| | remediation, response time, and |
| | documenting procedures and |
| | processes? |
| | 16. Is someone on the Board of Directors |
| | responsible for overseeing technology |
| | risk? |
| | Asset Management |
| | 17. Have you taken an inventory of each |
| | access point to your network (e.g., |
| | every connected device, wireless, |
| | remote, etc.), both inside and outside |
| | of the firewall, in order to identify |
| | potential points of vulnerability? |
| | 18. Have you conducted a business impact |
| | analysis? Consequently, do you have |
| | an asset based threat profile which |
| | would include a definition of potential |
| | impact to the enterprise should there be |
| | a breach in security (i.e. a loss of |
| | confidentiality, integrity or |
| | availability)? |
| | 19. What is included in your inventory of |
| | access points? |
| | 20. How often are risk assessments |
| | performed? Does an action plan result |
| | from each assessment? Is progress |
| | against the plan tracked and managed? |
| | 21. Does a network topology diagram |
| | exist, and if so, is it kept up-to-date? |
| | What is the update process, and how |
| | often, is it kept current? What trigger |
| | event must occur for it to be updated? |
| | 22. Are your systems properly configured |
| | according to your architecture? Who |
| | determines this? How often are |
| | configurations reviewed? |
| | 23. If a department is found to be non- |
| | compliant, do you have a policy for |
| | disciplinary action? What types of |
| | disciplinary actions do you impose? |
| | Who is responsible for their |
| | enforcement? |
| | 24. Are executive level e-risk summaries |
| | produced for the CEO, CTO, CFO and |
| | Board? Are they produced on at least a |
| | monthly basis? If not, how frequently? |
| | Does any action result on account of |
| | these summaries, and if so, what kind? |
| | 25. Do external partners implement the 18 |
| | layer security model? |
| | 26. Are there procedures and controls for |
| | purchasing and eliminating software |
| | and hardware? |
| | 27. Does the information technology |
| | management authorize all hardware |
| | and software acquisitions? |
| | 28. Are all aspects of Voice Over IP |
| | (VOIP) integrated into asset |
| | management? |
| | 29. Do you utilize a dedicated encryption |
| | processor for voice packet payloads? |
| | 30. Do you utilize Layer II switches |
| | instead of hubs? |
| | 31. Do you perform regular assessments of |
| | the call servers, router and switches |
| | within your VOIP network? |
| | 32. Are the elements of your VOIP |
| | network updated regular per patches? |
| | 33. Do you have an escalation process in |
| | place with your IP carrier? |
| | 34. Is a firewall and corresponding IDS |
| | employed to protect your voice |
| | network? |
| II. Policy | 1. Are the Board and Officers aware of |
| Management | their liabilities? Are personnel? |
| | 2. Has senior management, including the |
| | corporate or organizational Board of |
| | Directors, established a comprehensive |
| | information policy and auditing |
| | process? If so, what areas are covered? |
| | How, and how often are these policies |
| | reviewed, and how are they created? |
| | 3. Does your information security |
| | organization report to the IT |
| | organization, or is it a separate |
| | organization that maintains its |
| | independence and freedom from |
| | conflicts of interest? |
| | 4. Has senior management established a |
| | security auditing process? Do you use |
| | third party auditors? |
| | 5. Is someone responsible for each |
| | security policy and procedure? How |
| | does each policy “owner” stay current? |
| | Do they attend security conferences? |
| | What are the qualifications for being in |
| | this position? What mechanisms, etc. |
| | are in place to keep policies up-to- |
| | date? |
| | 6. Do current employees/users receive |
| | periodic security awareness training? |
| | 7. Are all users educated/trained as to the |
| | policies and procedures? Do all users |
| | have a copy of the policies and |
| | procedures? How do they demonstrate |
| | their acceptance of these as a part of |
| | their employment? |
| | 8. Are all business associations, partners, |
| | contractors or customers that have |
| | access to the company's computer |
| | systems made aware of the company's |
| | policies and procedures? |
| | 9. Must they agree to abide by the |
| | company's protocols in order to retain |
| | access? What occurs if business |
| | partners or customers are found to be |
| | non-compliant? |
| | 10. Do managers at each level of the |
| | organization understand their roles and |
| | responsibilities with respect to |
| | information security? How often does |
| | management receive security |
| | awareness training? How is that |
| | verified? |
| | 11. Do your security policies address both |
| | internal and external access to the |
| | network for each technological device? |
| | 12. Are users responsible for backing up |
| | their own user data on desktops, |
| | laptops, and mobile devices? |
| | 13. Do you have a process for retrieving a |
| | backup file that you inadvertently |
| | deleted? How long does this take? |
| | 14. Do users, including business associates |
| | and customers, know who to contact |
| | when they have problems with |
| | operating systems, laptops, access to |
| | new project data, passwords, security |
| | applications, or proprietary software? |
| | 15. Is policy management software (PMS) |
| | utilized? |
| | 16. Does your PMS manage the identified |
| | threats and vulnerabilities? |
| | 17. Does it map the threat intelligence to |
| | the protected assets of your |
| | organization? |
| | 18. Does it provide a policy management |
| | component related to policy and |
| | regulatory compliance? |
| | 19. Does it enable an organization to |
| | establish and manage a customized risk |
| | profile? |
| | 20. Remote System Access Policy |
| | 21. 21. Do system administrators note |
| | unusual access or instances of remote |
| | users? |
| | 22. 22. Do administrators regularly review |
| | all VPN log files, system log files, |
| | firewall logs, IDS logs, etc? |
| | 23. 23. Are laptops updated with critical |
| | patches and virus definitions prior to |
| | connecting to the network? If so how- |
| | manually or through SMS push? |
| | 24. Do users employ standardized |
| | equipment? |
| | 25. Is each user only assigned one remote |
| | computer? |
| | 26. Is each user held accountable for the |
| | actions of their computer? |
| | 27. Do remote users have access to |
| | sensitive or confidential information? |
| | 28. Do you utilize at least at a two-factor |
| | authentication system? |
| | 29. Are remote users required to utilize |
| | VPN and firewall software? |
| | 30. Do you utilize internal server software |
| | that checks for VPN firewall settings? |
| | Are users allowed to log on if a |
| | firewall is not in place? |
| | Personnel Policy |
| | 31. Do you conduct background checks on |
| | all personnel, including full and part- |
| | time employees, temps, outsourced |
| | vendors, and contractors? |
| | 32. Have you established proper use |
| | policies concerning employee E-mail, |
| | Internet, Instant Messaging, laptops, |
| | cellular phones, and remote access? |
| | 33. Who establishes and enforces these |
| | proper use policies? |
| | 34. Are all employees trained on network |
| | security basics? |
| | 35. Are employees held accountable for |
| | Internet activity associated with their |
| | accounts? |
| | 36. Are employees certified or verified |
| | after reviewing company policies? |
| | 37. Do employees have an available and |
| | reliable mechanism to promptly report |
| | security incidents, weaknesses, and |
| | software malfunctions? |
| | Outsourcing Policy |
| | 38. Have you established policies to |
| | restrict, control, or monitor systems |
| | access by vendors, contractors, and |
| | other outsourced personnel? |
| | 39. Do outsourced personnel sign non- |
| | disclosure agreements? |
| | 40. Are all employees required to receive |
| | information security awareness |
| | training? Is there a testing component |
| | to verify and validate such training? |
| | 41. If outsourcing/contracting certain |
| | services, are the security controls |
| | under direct authority of your CISO |
| | within the contract? |
| | 42. Do procedures exist to determine the |
| | security impact of linking new/external |
| | systems to the organization's |
| | infrastructure? |
| | 43. Do outsourced companies implement a |
| | physical access policy? Are physical |
| | parameters and security measures |
| | implemented? |
| | 44. Who is responsible for the adequacy of |
| | policies, procedures and standards that |
| | govern security requirements for |
| | outsourced service providers, customers, |
| | and business associates? How often are |
| | these reviewed? |
| | At a minimum, policies, procedures and |
| | standards should address: |
| | Due diligence requirements; |
| | Security service level and operational |
| | readiness requirements; |
| | The general security scope and timing of |
| | third-party assurance reviews (e.g., SAS70 |
| | Level II, SysTrust, WebTrust |
| | certifications); |
| | Existence & adequacy of insurance to |
| | protect against financial losses due to third- |
| | party negligence and/or unauthorized |
| | access to service provider systems; |
| | Privacy policy; |
| | Disaster recovery and business continuity |
| | plan; |
| | Process of change management. |
| | 45. Who reviews internal audits |
| | performed on service providers? These |
| | should specifically assess: |
| | The adequacy of the scope and |
| | frequency of review, sufficiency of |
| | supporting work papers; significance |
| | of audit findings; |
| | Conduct a gap analysis of audit |
| | coverage to identify areas that are not |
| | covered, or inadequately covered, by |
| | the internal audit function; and |
| | Is there a follow-up with whom to |
| | remediate? |
| | 46. What legal requirements are your |
| | hosting companies, data warehousers, |
| | software developers or application |
| | service providers contractually |
| | obligated to fulfill regarding security, |
| | e.g. duties, layers of security, |
| | notification of security breaches, and |
| | timeliness of responses? |
| | 47. Does the outsourced entity have a |
| | formal and documented security |
| | procedure? Is this available for review? |
| | 48. Are written job descriptions available |
| | to all outsourced personnel who have |
| | access to sensitive information? Are |
| | background checks conducted? |
| | 49. Do agreements with your outsourced, |
| | network service providers contain |
| | proper incentives and financial |
| | repercussions for instances of service |
| | outages? |
| | 50. Are outsourced security policies |
| | constantly updated? |
| | 51. Are consequences for non-compliance |
| | with policies clearly documented and |
| | enforced? |
| | 52. Are outsourced entities required to |
| | report security incidents to you and |
| | depict their response and remediation |
| | of such incidents? |
| | 53. Do your outsourced providers have |
| | backup facilities? |
| | 54. Are outsourced entities required to be |
| | insured? |
| | 55. Does the outsourced company maintain |
| | an asset control and security policy? |
| | Physical Security Policy |
| | 56. Do your security policies restrict |
| | physical access to networked systems |
| | facilities? |
| | 57. Are your physical facilities access- |
| | controlled through biometrics or smart |
| | cards, in order to prevent unauthorized |
| | access? |
| | 58. Does someone regularly check the |
| | audit trails of key card access systems? |
| | Does this note how many failed logs |
| | have occurred? |
| | 59. Are backup copies of software stored |
| | in safe containers? |
| | 60. Are your facilities securely locked at |
| | all times? |
| | 61. Do your network facilities have |
| | monitoring or surveillance systems to |
| | track abnormal activity? |
| | 62. Have you identified the most |
| | vulnerable locations for the |
| | organization? |
| | 63. Have you hardened the vulnerable |
| | sites? |
| | 64. Do you encourage geographic |
| | diversity? |
| | 65. Do you frequently back up and |
| | verify the integrity of critical data and |
| | position it with the requisite personnel |
| | skill set to deploy it? |
| | 66. Do you map critical nodes and |
| | paths to enable near instantaneous |
| | assessment of network impacts? |
| | 67. Do you have a detailed, written |
| | contingency plan with specific |
| | individuals and backups identified? |
| | 68. Do you periodically exercise the |
| | procedures to allow refinement and |
| | correction of any actions or activities? |
| | 69. Have you arranged for a mobile, |
| | rapidly deployable capability for |
| | providing backup switching, |
| | connectivity bridging and/or |
| | emergency power? |
| | 70. Are all unused “ports” turned off? |
| | 71. Are your facilities equipped with |
| | alarms to notify of suspicious |
| | intrusions into systems rooms and |
| | facilities? |
| | 72. Are cameras placed near all sensitive |
| | areas? |
| | 73. Do you have a fully automatic fire |
| | suppression system that activates |
| | automatically when it detects heat, |
| | smoke, or particles? |
| | 74. Do you have automatic humidity |
| | controls to prevent potentially harmful |
| | levels of humidity from ruining |
| | equipment? |
| | 75. Do you utilize automatic voltage |
| | control to protect IT assets? |
| | 76. Are ceilings reinforced in sensitive |
| | areas e.g. server room? |
| | 77. Are camera phones banned from all |
| | sensitive areas? |
| | 78. Are flash memory devices banned? |
| | 79. Have audits for rootkits been |
| | preformed? |
| | Insider Threat Management¹ |
| | 1. Does a formal computer ethics and |
| | hygiene training program exist for all |
| | employees? All users must affirm that |
| | they are aware of policies concerning |
| | employee E-mail, Internet, Instant |
| | Messaging, laptops, cellular phones, |
| | and remote access. Someone should be |
| | responsible for enforcing these |
| | policies, e.g., The Information Security |
| | Policy? Has this process been |
| | documented? |
| | 2. Has a formal process been created for |
| | reporting negative “anti-enterprise” |
| | behavior by employees? Are these |
| | reports briefed to management in a |
| | timely fashion? |
| | 3. Is there a three strike rule for |
| | disciplinary actions against |
| | employees? |
| | 4. Are backdoor audits conducted on |
| | employees computers who are |
| | disillusioned e.g. troubled? Are |
| | “sniffers” placed on those machines |
| | thereafter? |
| | 5. Is each user only granted access to data, |
| | which the user has a valid need to |
| | know? Are “troubled” employees |
| | permitted sys admin access? |
| | 6. Are the following logs reviewed |
| | regularly as they relate to “troubled” |
| | users accounts? |
| | * Remote access logs |
| | * File access logs |
| | * Database logs |
| | * System File Change logs |
| | * Email logs |
| | 7. Is Physical access to networked |
| | systems facilities made by employees, |
| | contract employees, vendors, and |
| | visitors restricted? |
| | 8. Does a procedure exist for employee |
| | termination? If are all computer |
| | accounts terminated prior to |
| | notification by management? Are all |
| | corporate computers repossessed? |
| | 9. To protect your networks, do you use |
| | some form of behavior modeling such |
| | as social network analysis? |
| | 10. Have you developed a system for user |
| | profiling that asks the following |
| | questions: |
| | Who are you? |
| | Are you who you say you are? |
| | 11. Are all activities accountable and |
| | traceable to an individual? |
| III. Cyber- | 1. Does your organization conduct cyber- |
| Intelligence | intelligence gathering? |
| | 2. Are intelligence reports disseminated |
| | to your information systems group? |
| | 3. Does cyber-intelligence reporting |
| | include malicious code? ²Geopolitical |
| | threats? Both known and unknown |
| | vulnerabilities? Predictive analysis |
| | related to emerging cyber-threats? |
| | 4. How does the cyber-threat intelligence |
| | provider measure performance? |
| | 5. Do you conduct 24 × 7 monitoring and |
| | intrusion detection as a part of your |
| | cyber-intelligence gathering? |
| | Patch Management |
| | 6. When applying a patch to any system |
| | vulnerability, do you have a process |
| | for verifying the integrity, and testing |
| | the proper functioning of the patch? |
| | 7. Have you verified that the patch will |
| | not negatively affect or alter other |
| | system configurations? |
| | 8. Are patches tested on test beds before |
| | being released into the network? |
| | 9. Do you make a backup of your system |
| | before applying patches? |
| | 10. Do you conduct another vulnerability |
| | test after you apply a patch? |
| | 11. Do you keep a log file of any system |
| | changes and updates? |
| | 12. Are patches prioritized? |
| | 13. Do you disseminate patch update |
| | information throughout organization's |
| | local systems administrators? |
| | 14. Do you add timetables to patch |
| | potential vulnerabilities? |
| | 15. Are external partners required to patch |
| | all non-critical patches within 30 |
| | days? |
| | 16. Are external partners required to patch |
| | critical patches3 to servers and clients |
| | within 48 hours? |
| IV. Access | 1. Is two-factor authentication utilized |
| Controls/ | for large value payments and system |
| Authentication | administrators? |
| | 2. Are policies and procedures |
| | documented that are used for both |
| | establishing and termination of access |
| | for consultants and employees? |
| | 3. Are users required to use robust |
| | passwords (long in length; mix of |
| | letters, numbers, and symbols)? |
| | 4. Do you provide automated |
| | enforcement for changing passwords? |
| | How often? |
| | 5. Are user ID's and passwords unique to |
| | each individual network user? |
| | 6. Do you prevent the use of shared, or |
| | group, user ID's? |
| | 7. If biometrics are employed, are “live- |
| | scans” conducted to verify the |
| | presence of the user? |
| | 8. Does your biometric system have a |
| | secure and reliable enrollment |
| | process? |
| | 9. Once a user's biometric information is |
| | recorded, is security in place to protect |
| | that information against theft, |
| | alteration, or forgery? |
| | 10. Do decision processes and supporting |
| | procedures exist to permit third party |
| | access (e.g. contract employees, |
| | customers, etc.)? |
| | 11. Do third parties retire or update |
| | accounts when partnerships terminate? |
| | 12. How do users access the |
| | organization's network and systems |
| | when working from home or when |
| | traveling? Who authorizes generic |
| | employee access? |
| | 13. Compared to what a user can do when |
| | physically working in the office, is |
| | remote access restricted? If so, how is |
| | this achieved? |
| | 14. Is access restricted to the minimum |
| | amount of access necessary for any |
| | particular job? |
| | 15. Are root-level, and other privileged |
| | access, given only on an as-needed |
| | basis? Upon what criteria is this |
| | based? |
| | 16. Do you deactivate the access controls |
| | of an employee to both the building |
| | and computer networks prior to the |
| | employee's termination? What other |
| | precautions are taken before or after |
| | an employee's termination? |
| | 17. Are all your access controls and |
| | authentication mechanisms monitored |
| | to correct instances of false |
| | positive/negatives? Explain. |
| | 18. Do you check for modems attached to |
| | PCs, routers or printers? |
| | 19. Do you periodically war-dial your |
| | telephone number range to check for |
| | new devices? |
| | 20. Do you utilize a private branch |
| | exchange (PBX) firewall, PBX log or |
| | other such control to keep track of any |
| | attempts to hack into systems using |
| | war dialing techniques? |
| | 21. Do you have controls in place to |
| | detect modem scanning attempts on |
| | your systems? |
| V. Firewalls | 1. Do you use nationally certified |
| | firewalls? If there is no national |
| | certification, what criteria do you use |
| | to purchase firewalls? |
| | 2. Do you have a comprehensive list of |
| | what should be allowed/disallowed |
| | through the firewall? Is this document |
| | kept up-to-date? |
| | 3. Where do you place firewalls? How |
| | do you secure them against |
| | unauthorized access from Internet, |
| | Extranet and Intranet users? E.g., are |
| | inner firewalls placed around all |
| | critical, financial and transactional |
| | systems? |
| | 4. Do you place firewalls at all sub- |
| | network boundaries where policies |
| | differ between the connecting sub- |
| | networks? |
| | 5. Is the firewall placed in between the |
| | network router and the network or |
| | given application? |
| | 6. Do you prevent entry or exit through |
| | any network port that is not required |
| | by your organization? |
| | 7. Do you prevent use of any network |
| | protocol not in use by your |
| | organization? |
| | 8. Are your routers properly configured |
| | for your system requirements? How |
| | has this been verified? |
| | 9. Are default router configurations used, |
| | and are they set to Default/Deny? |
| | 10. Are rule sets backed up and tested |
| | regularly? |
| | 11. Are your firewalls configured such |
| | that servers that should accept only |
| | inbound connections (e.g. Web |
| | servers) are prohibited from making |
| | outbound connections? |
| | 12. Are your firewalls updated at regular |
| | intervals? How often? Is it updated |
| | when a patch is available? What |
| | initiates a review? |
| | 13. Do you use ingress and egress |
| | filtering? Do you follow the following |
| | filtering rules listed in the Appendix? |
| | If so, which ones do you follow? |
| | 14. Do you employ rate-limiting filters? |
| | 15. If users are allowed to connect from |
| | the Internet to the internal network, is |
| | access restricted to either a virtual |
| | private network (VPN) or an |
| | encrypted software session? How is it |
| | restricted? |
| | 16. Is access to the management interfaces |
| | of routers, firewalls and other network |
| | appliances adequately secured? For |
| | example, are these devices also |
| | subject to appropriate password policy |
| | enforcement, or is two factor |
| | authentication employed? |
| | 17. Do you explicitly configure your |
| | network to restrict access for |
| | everything that does not need to enter |
| | your firewall? Please see Appendix |
| | for technical examples. |
| | 18. Is firewall administration limited to |
| | authorized staff? |
| VI. Active | 1. Is your system configured to filter |
| Content Filtering | hostile Active X? |
| | 2. Is your system configured to filter |
| | JavaScript? |
| | 3. Is your system configured to filter |
| | Remote Procedure Calls (RPCs)? |
| | 4. Is your system configured to filter |
| | Perimeter-Based Security (PBS)? |
| | 5. Is your system configured to filter |
| | Berkeley Internet Name Domain |
| | (BIND)?⁴ |
| | 6. Is your system configured to filter |
| | Simple Network Management |
| | Protocol (SNMP)? Please see |
| | Appendix for details. |
| | 7. Is your system configured to filter the |
| | Java Virtual Machine (JVM) |
| | vulnerability? |
| | 8. Have you upgraded to the latest |
| | version of Sendmail and/or |
| | implemented patches for Sendmail ? |
| | 9. Do you prevent Sendmail to run in |
| | daemon mode (turn off the - bd switch) |
| | on machines that are neither mail |
| | servers nor mail relays? |
| | 10. Is your system configured to filter |
| | Internet Message Access Protocol |
| | (IMAP) and Post Office Protocol |
| | (POP)? |
| | 11. Is your system configured to filter |
| | Sadmind and mountd? Please see |
| | Appendix for details. |
| | 12. Does your organization have a |
| | standard desktop configuration and |
| | software standards? |
| | 13. Do you employ enterprise level |
| | desktop configuration management? |
| | 14. Is your system configured to filter E- |
| | mail? Have you considered filtering |
| | all arriving and departing e-mail by a |
| | spam threshold (greater than 40 |
| | identical messages blocked and source |
| | traced, if inside the network)? |
| | 15. Do you filter all .exe, .zip, and .doc |
| | attachments? |
| | 16. Do you implement XML filtering and |
| | layered security?5 |
| | Web Application Security |
| | 17. Do you check the lengths of all input? |
| | If greater than the maximum length, |
| | do you stop processing and return as |
| | failure? |
| | 18. Do you allow source packets coming |
| | from outside to have internal IP |
| | addresses. Conversely, do not allow |
| | inside packets to go out that do not |
| | have valid internal IP source |
| | addresses. |
| | 19. Are user names and passwords sent in |
| | plaintext over an insecure channel? |
| | 20. Do you restrict user access to system- |
| | level resources? |
| | 21. Do you limit session lifetimes? |
| | 22. Do you encrypt sensitive cookie |
| | states? |
| | Web Server Security |
| | 23. Remember that default installation of |
| | HTTP can lead to DDoS⁶ attacks and |
| | exposure of confidential information |
| | making the server vulnerable to an |
| | attack. |
| | 24. Have you incorporated SSL or SSH? |
| | 25. Do not run other applications on |
| | system. Limit to HTTP and any other |
| | services required. |
| | 26. Have you applied latest service packs, |
| | updates and patches? |
| | 27. Is ftp, telnet, bash, etc banned? |
| | 28. Access Control issues. Do you |
| | Restrict user list from accessing web |
| | server? Is Two factor authentication |
| | implemented? |
| | 29. Is Vulnerability scanning utilized to |
| | check for buffer overflows? |
| | 30. Is Change control implemented to |
| | reduce overall risk? Are system |
| | changes tracked and monitored? |
| | 31. Do you remove any sample CGI |
| | programs from the server? |
| | 32. Do you run web application scanner |
| | such as ScanDo or Appscan to |
| | simulate an attack of the website and |
| | determine its security? Run it often |
| | during design phase and implement |
| | weekly scans to check for new |
| | vulnerabilities. |
| | 33. Do you Review all logs frequently? |
| | All logging should be turned on. If |
| | possible one should push all logs to |
| | central location to check for trends or |
| | similarities between other web |
| | servers. |
| | 34. Do you carefully plan and address the |
| | security aspects of the deployment of |
| | any public web server?⁷ |
| | 35. Do you implement appropriate |
| | security management practices and |
| | controls when maintaining and |
| | operating a secure web presence?⁸ |
| | 36. To ensure the security of the web |
| | server and the supporting network |
| | infrastructure, the following practices |
| | have been implemented: |
| | Organizational-wide information system |
| | security policy. |
| | Configuration/change control and |
| | management. |
| | Risk assessment and management. |
| | Standardized software configurations |
| | that satisfy the information system |
| | security policy. |
| | Security awareness and training. |
| | Contingency planning, continuity of |
| | operations, and disaster recovery. |
| | Certification and accreditation. |
| VII. Intrusion | 1. What types of intrusion detection |
| Detection | systems (IDS) are used? How is their |
| | placement/location determined? |
| | 2. Is your IDS outsourced? If so, what are |
| | your criteria for choosing an |
| | outsourced vehicle? |
| | 3. Do you use host-based and network- |
| | based intrusion detection systems? |
| | How often is this updated? |
| | 4. Who maintains and configures rule sets |
| | and routing controls, and what is their |
| | process for doing so? |
| | 5 Are IDS systems appropriately |
| | configured for system anomalies, file |
| | and data problems, and aberrant usage? |
| | 6. Are your IDS programs updated on a |
| | regular and frequent schedule? If so, |
| | how often? Upon what criteria is it |
| | updated? |
| | 7. Are all system logins and intrusions |
| | being tracked? If so how often? If logs |
| | are kept, how frequently are they |
| | reviewed? Do metrics exist where the |
| | intrusions are tracked? |
| | 8. Are log files kept in a secure location, |
| | and are they protected against |
| | malicious access, including any |
| | alteration or deletion? Who has access |
| | to them? Does management review |
| | these on a regular basis? |
| | 9. Do you conduct frequent vulnerability |
| | testing against your IDS systems? |
| | 10. Who conducts your vulnerability |
| | testing? |
| | 11. What is the criterion for choosing a |
| | vulnerability tester? |
| | 12. Understanding that applications such |
| | as VPNs conceal malicious code from |
| | IDS programs, do you use additional |
| | layers of defense to protect these |
| | programs? |
| | 13. Is the use of open source IDS software |
| | investigated? |
| | 14. Do you subscribe to alerts on the latest |
| | threats and vulnerabilities? |
| | 15. Who is responsible for keeping records |
| | of cyber-intrusions, cost of |
| | remediation, etc? |
| | 16. Are you certain your IDSes are seeing |
| | all of the data? Of 100 “test” attacks |
| | you inject on your network, how many |
| | does the IDS see? How many packets |
| | per second are being processed by your |
| | IDS? |
| | 17. Is your IDS set up in a redundant |
| | and/or load sharing fashion? |
| | 18. Do you use span ports on switches, |
| | hubs, or passive fiber taps to |
| | accomplish IDS? If hubs are used, how |
| | do you ensure that someone can not |
| | plug another device into the hub, and |
| | thereby view all of your networks |
| | data? |
| | 19. Does the IDS page or email security |
| | personnel? Of 5 injected attacks, how |
| | many times did security personnel |
| | respond? |
| | 20. Are your IDS rule-sets protected (i.e.: |
| | what does your IDS look for, what are |
| | the time deltas that it uses to detect |
| | network scanning)? E.g. If someone |
| | can find the rule set they know what |
| | you are/not looking for. |
| | 21. Are all system clocks set to the exact |
| | same time? |
| | 22. Do you keep a profile of general |
| | characteristics for each server? These |
| | can great aid in incident analyses. |
| | 23. Are honey pots utilized? If so, where |
| | are the placed? |
| | 24. Do you keep logs of any honey pot |
| | activity? |
| | 25. Do you check for signs of rogue |
| | tunnels (see appendix)? |
| VII. Virus | 1. Are anti-virus signatures updated on a |
| Scanners | daily basis? |
| | 2. Are all executable attachments filtered |
| | in email? |
| | 3. What actions do you take if you |
| | discover a virus? Are these procedures |
| | documented? |
| | 4. How do you recover compromised |
| | files? Do you document these actions? |
| | 5. How do you contain the damage |
| | caused by a virus? Do you document |
| | instances of viruses? (Refer to the |
| | Appendix for more detailed |
| | “debotting” instruction.) |
| | 6. Do you document the actions taken to |
| | eradicate and prevent future instances |
| | of these viruses? |
| | 7. How do you avoid propagating a virus |
| | to others? Do you document these |
| | procedures? |
| | 8. Do you minimize the risks of virus |
| | propagation by limiting the use of disk |
| | drives, and by limiting or restricting |
| | software downloads/uploads? |
| | 9. How do you verify that a recently |
| | created file has not been infected? |
| | 10. Do computer systems run automatic |
| | and routine virus scans? |
| IX. Encryption | 1. Is the level of SSL encryption 128 BIT |
| | or higher? |
| | 2. Is there an established policy regarding |
| | the sharing of your public key with |
| | others and how they share theirs with |
| | you? |
| | 3. When utilizing RSA, is the level of |
| | encryption at least 1024 bits? |
| | 4. Are keys stored in a secure location? Is |
| | there adequate protection against theft, |
| | disclosure, and alteration? |
| | 5. Do you have a secure means by which |
| | to issue keys? |
| | 6. Are secret keys unlocked securely? |
| | 7. Is use of root keys tightly controlled?⁹ |
| | 8. How are encryption keys managed, |
| | including key retirement/replacement |
| | when someone who has access leaves |
| | the organization? |
| | 9. Do encrypted keys contain expiration |
| | dates? |
| | 10. Is there a secure means for replacing |
| | keys? |
| | 11. Is there a secure way of destroying |
| | keys? |
| | 12. Are the CRL (Certificate Revocation |
| | Lists) maintained on a real-time basis? |
| | 13. Are certificates properly validated |
| | against the hostnames/users for whom |
| | they are meant for? |
| | 14. Do you have a policy for cross- |
| | certification with external parties? |
| | 15. Do you have a contingency plan that |
| | can recover data in the event of an |
| | encrypted key being lost? |
| | 16. Do you archive private keys? Is there a |
| | policy in place to retrieve archived |
| | keys if needed in future? |
| X. | 1. Are vulnerability tests conducted on a |
| Vulnerability | quarterly basis? |
| and Penetration | 2. Are the results acted upon? |
| Testing | 3. Are penetration tests conducted on a |
| | bi-annual basis? If they are conducted |
| | do they address the following: |
| | a. Describing threats in terms of |
| | who, how and when |
| | b. Establishing into which threat |
| | class a threat falls |
| | c. Determining the consequences on |
| | the business operations should a |
| | threat be successful |
| | d. Assessing the impact of the |
| | consequences as less serious, |
| | serious or exceptionally grave |
| | injury |
| | e. Assigning an exposure rating to |
| | each threat, in terms of the |
| | relative severity to the business |
| | prioritization of the impacts |
| | according to the exposure rating |
| | 4. Is there a timetable for acting upon the |
| | above results? |
| | 5. Do penetration tests assess both the |
| | external and insider threat? |
| | 6. Do your tests include performing a |
| | network survey, port scan, application |
| | and code review, router, firewall, IDS, |
| | trusted system and password cracking? |
| | 7. Do you employ network sniffers to |
| | evaluate network protocols along with |
| | the source and destination of various |
| | protocols for stealth port scanning and |
| | hacking activity? |
| | 8. Are penetration tests conducted upon |
| | hosting provider systems and existing |
| | partner systems before connecting |
| | them to the organization's network? |
| | 9. Are vulnerability/penetration testing |
| | results shared with all appropriate |
| | security and network administrators? |
| | 10. Do your penetration tests encompass |
| | social engineering? |
| XI. Systems | 1. Before new technology is deployed, is |
| Administration | a security peer review criteria |
| | published and subsequently reviewed? |
| | 2. Are short timetables mandated for the |
| | test and installation of software patches |
| | that fix security flaws? |
| | 3. Are daily audits of network logs |
| | conducted? |
| | 4. Are default software settings changed |
| | to ensure a secure configuration? |
| | 5. Is the use of SNMP, telnetd, ftpd, mail, |
| | rpc, rservices, or other unencrypted |
| | protocols for managing systems |
| | prohibited? |
| | 6. If Instant Messaging is employed, is it |
| | necessary for business? And is it |
| | properly encrypted? |
| | 7. Do you prohibit passwords |
| | assignments over the telephone, IM, or |
| | other unsecured transmission |
| | mechanisms? |
| | 8. Are passwords encrypted during both |
| | transmission and storage? |
| | 9. Are administrative accounts and |
| | passwords shared over multiple |
| | systems? |
| | 10. Are administrative accounts changed |
| | quarterly with very strong passwords? |
| | 11. When resetting passwords, can users |
| | utilize a password they entered in the |
| | past? |
| XII. Incident | 1. Does the IRP provide guidance on |
| Response Plan | what to do if there is an attack? |
| (IRP) | 2. At what point do you report an |
| | incident? To whom do you report this |
| | incident? |
| | 3. What is your escalation procedure? |
| | Do incident responders determine |
| | what systems were attacked? Do |
| | incident responders determine how |
| | attacked systems were affected? |
| | 4. At what point do you determine if this |
| | is a crime scene? |
| | 5. Is there an attempt to trace the source |
| | of the attack? |
| | 6. Can you determine the servers from |
| | which intruder data was sent? |
| | 7. Can you determine downstream victim |
| | sites? How is this determined? |
| | 8. For the purpose of forensics are the |
| | logs secure and images of the |
| | compromised server taken? Do your |
| | policies and procedures for IRP |
| | address: |
| | a. Evidence collection and technical |
| | & investigative guidelines; |
| | b. Documentation & preservation |
| | processes; |
| | c. Data & information analysis; |
| | d. Requirements for completing |
| | SARs and other law enforcement |
| | documentation (e.g., USSS |
| | Network Incident Report); |
| | e. Legal guidelines and constraints |
| | (e.g., journaling criteria, including |
| | legal review); |
| | f. Computer forensics tool selection |
| | process. |
| | 9. Does the IRP provide you with a |
| | description of the authority and |
| | discretion you have when responding? |
| | E.g. Key points of contact and |
| | communication channels (e.g., law |
| | enforcement, regulatory agencies, |
| | public relations, internal |
| | communications) |
| | 10. If the incident resulted from an |
| | unpatched vulnerability, is the patch |
| | acquired, tested, and installed in a |
| | timely manner? |
| | 11. Are searches conducted for backdoors |
| | and other unexpected violations of |
| | integrity? |
| | 12. Are compromised systems repaired? |
| | If so, are the repaired in a timely |
| | fashion? |
| | 13. Is a disaster recovery plan in place? |
| | 14. Do you have cyber-insurance |
| | coverage for cyber-risks or fraud due |
| | to the internal and/or external |
| | hackers? |
| | 15. Are system back-ups and redundant |
| | servers in place in the event of a |
| | system failure or attack? What is the |
| | distance between the primary and |
| | backup servers? |
| | 16. Is the backup facility on a different |
| | power grid than the primary facility? |
| | 17. Are the facilities served by the same |
| | or different telecommunications |
| | exchanges? |
| | 18. Are the disaster recovery facilities |
| | sufficient to allow continued |
| | operations in the event of a regional |
| | disaster? |
| | 19. Do secondary systems undergo |
| | thorough security maintenance, |
| | including abiding by all security |
| | policies and procedures? |
| | 20. Have you identified authorized |
| | personnel to manage contingency |
| | plans? |
| | 21. Are authorized personnel responsible |
| | for evidentiary data workflow |
| | management (e.g., journaling, audit |
| | trails, etc.) and completion of internal |
| | and external network incident reports |
| | (U.S. Secret Service), SARs, |
| | regulatory and other reports? |
| | 22. Do you have procedures and processes |
| | for securely switching to and from |
| | back-up systems, including expiring |
| | or short-term access privileges? |
| | Forensics |
| | 23. Do you employ a digital forensic |
| | policy? |
| | 24. Do you have evidentiary data |
| | guidelines and preservation practices?¹⁰ |
| | 25. Do you provide or utilize |
| | comprehensive digital forensics training? |
| | 26. Do you provide a post-mortem |
| | “lesson's learned” analysis? |
| XIII. Wireless | 802.11 |
| | 1. Is there an institution-wide wireless |
| | policy? Is this clearly exhibited to all |
| | employees? |
| | 2. Are all wireless connections mandated |
| | to register? |
| | 3. Is someone responsible for tracking |
| | the number of employees with |
| | WLANs at home? |
| | 4. Have all unnecessary services and |
| | applications on each client and server |
| | been disabled? |
| | 5. Have all default settings, including |
| | passwords, been changed? |
| | 6. Have you limited radius coverage to |
| | the windows, and not beyond? |
| | 7. Have bi-directional antennas been |
| | provided for all wireless devices? |
| | 8. Do you have a VPN endpoint inside a |
| | wireless DMZ? |
| | 9. Have you deployed VPN tunneling |
| | between the network firewall and the |
| | wireless devices? |
| | 10. Have you installed enterprise-wide |
| | antiviral software on all wireless |
| | clients? |
| | 11. Has two-factor authentication been |
| | employed? Where? Why? |
| | 12. Have you disabled DHCP and the use |
| | of static IP addresses for wireless |
| | network interface cards (NICs)? |
| | 13. Have you disabled all Simple Network |
| | Management Protocol (SNMP) |
| | community passwords on all access |
| | points? |
| | 14. Do access points contain “flashable” |
| | firmware only? |
| | 15. Are wireless firewall gateways used? |
| | Where? Why? |
| | 16. Are Access Points (AP) placed in |
| | secure areas, and are Layer 2 switches |
| | employed in lieu of hubs? |
| | 17. Do you employ a network-based |
| | intrusion detection system on the |
| | wireless network? |
| | 18. Do you perform routine checks to find |
| | rogue access points? |
| | 19. Do you monitor all wireless logs at |
| | least once a week? Do you scan |
| | critical host logs daily? |
| | 20. Do you employ two-factor |
| | authentication on all wireless devices? |
| | 21. Have you moved or encrypted the |
| | SSID password and the WEP key? |
| | 22. Have you disabled SNMP community |
| | passwords on all access points? |
| | 23. Have you enabled 128-bit WEP |
| | encryption? |
| | Hot Spot Security |
| | 24. Before going to a public hotspot did |
| | you, turn off, file and printer sharing |
| | protocols for your wireless network |
| | card. |
| | 25. (Windows XP users) Have you |
| | cleared your list of preferred network |
| | prior to using a pubic hotspot? |
| | 26. (Windows XP users) Have you |
| | selected Access point (infrastructure) |
| | networks only in the Wireless |
| | Network Configuration screen? |
| | 27. Did you use software provided by the |
| | hotspot provider (downloadable from |
| | their website)? |
| | 28. Have you checked website certificates |
| | for their authenticity? |
| | 29. Have you made sure all data to be |
| | transmitted over a public hotspot is |
| | encrypted? |
| | 30. Did you avoid transmitting personal |
| | information when using a wireless |
| | network hotspot? |
| | GSM |
| | 31. Is a power-on password required? |
| | 32. Do PDAs have anti-virus and VPN |
| | software installed? |
| | 33. Is robust encryption utilized? |
| | 34. Are users required to store devices |
| | securely |
| | 35. Do you ensure that desktop mirroring |
| | software is password protected? |
| | Satellite Security “GPS” |
| | 36. Have you implemented adequate |
| | security around your GPS receivers? |
| | Please see Appendix for details. |
| XIV. | Certification |
| Certification and | 1. Is there an institution-wide |
| Accreditation | certification and accreditation policy? |
| | Is it consistent with other |
| | organizational policies? |
| | 2. Are certification and accreditation |
| | policies and procedures documented |
| | and distributed to the appropriate |
| | personnel? |
| | 3. Are the certification and accreditation |
| | procedures comprehensive enough to |
| | meet the requirements of the |
| | certification and accreditation policy? |
| | 4. Has the responsibility for |
| | implementing the organization's |
| | certification and accreditation |
| | program been assigned to specific, |
| | appropriate individuals? |
| | 5. Have the organization's security |
| | controls been assessed for proper |
| | implementation? |
| | 6. Are security control assessments |
| | conducted at minimum intervals |
| | specified by the organization's |
| | certification and accreditation policy? |
| | 7. Have faults that have been identified |
| | in security controls been addressed |
| | and corrected in a timely manner? |
| | 8. Are security controls being improved |
| | on a continuous process improvement |
| | basis? |
| | 9. Have all connections to external |
| | sytems outside of the certification |
| | and accreditation boundary been |
| | identified? |
| | 10. Are all connections to information |
| | systems outside of the certification |
| | and accreditation boundary authorized |
| | and approved? |
| | 11. Is certification being applied in |
| | accordance with standard certification |
| | procedures, such as NIST SP 800-37? |
| | 12. Are certification assessments |
| | conducted on a regular, prescribed |
| | basis? |
| | 13. Are certifications conducted by |
| | independent certification teams? |
| | 14. Are the results of certification |
| | assessments used to support plans for |
| | continuous improvement? |
| | Accreditation |
| | 15. Is the accreditation process conducted |
| | in accordance with established |
| | standards such as NIST SP 800-37? |
| | 16. Are specific individuals assigned |
| | responsibility for conducting |
| | accreditation procedures at regular |
| | intervals or when significant changes |
| | to the information system have |
| | occurred? |
| | 17. Has a senior management officer been |
| | assigned the responsibility for signing |
| | the accreditation document or the |
| | interim authority to operate? |
| | 18. Does the organization use the results |
| | of the accreditation process as part of |
| | a continuous improvement program? |
| XV. | Policy |
| Configuration | 1. Is there an institution-wide |
| Management | configuration management policy? |
| | 2. Is the configuration management |
| | policy reviewed at specified intervals? |
| | Is it up to date and distributed to the |
| | appropriate parties |
| | 3. Are the configuration management |
| | policies and corresponding procedures |
| | coordinated with the needs and |
| | requirements of the organization? |
| | 4. Are configuration management |
| | responsibilities assigned to specific, |
| | appropriate individuals? |
| | 5. Have configuration management |
| | controls been defined and |
| | implemented? |
| | 6. Are configuration management |
| | policies and procedures applied |
| | consistently? |
| | Baselines |
| | 1. Does the organization maintain |
| | baseline configurations of their |
| | information systems? |
| | 2. Are specific individuals assigned the |
| | responsibility of developing the |
| | information system baseline |
| | configurations? |
| | 3. Has the organization developed an |
| | inventory of the hardware, firmware, |
| | and software components of the |
| | information system? |
| | 4. Has the organization defined the |
| | ownership of the hardware, firmware, |
| | and software components? |
| | 5. Has the organization specified the |
| | hardware, firmware, and software |
| | components that are necessary for |
| | business continuity/disaster recovery |
| | programs? |
| | 6. Are changes to the information system |
| | inventory accurate and up-to-date? |
| | 7. Has the organization specified a |
| | frequency of evaluating and updating |
| | the inventory and baseline |
| | configuration? |
| | 8. Does the organization define events |
| | that will cause the inventory and |
| | configuration to be updated? |
| | 9. Does the organization record the |
| | names of individuals who have made |
| | the updates? |
| | 10. Does the organization use automated |
| | methods to develop and maintain the |
| | current baseline system configuration? |
| | 11. If automated methods are employed, |
| | have they been evaluated to ensure |
| | that they properly and consistently |
| | maintain the baseline configuration? |
| | Change Control |
| | 1. Has the organization assigned |
| | responsibilities to specific individuals |
| | for change control? |
| | 2. Are Access Points (AP) placed in |
| | secure areas, and are Layer 2 switches |
| | employed in lieu of hubs? |
| | 3. Does the organization consistently and |
| | accurately document information |
| | system configuration changes? |
| | 4. Do the individuals responsible for |
| | configuration changes approve such |
| | changes in accordance with the |
| | appropriate policies? |
| | 5. Is change control used as a component |
| | of the continuous improvement |
| | process? |
| | 6. Does the organization use automated |
| | methods to oversee and management |
| | configuration change control? |
| | 7. If automated methods are employed, |
| | have they been evaluated to ensure |
| | that they properly and consistently |
| | manage the change control tasks? |
| XVI. | I/O Controls |
| Input/Output | 1. Is there an institution-wide policy that |
| | addresses input/output and production |
| | controls? |
| | 2. Are there processes in place to protect |
| | printer outputs or information in other |
| | electronic form from unauthorized |
| | personnel? |
| | 3. Is the handling and retrieval of printed |
| | information or information in other |
| | electronic form tracked and audited? |
| | 4. Have procedures and controls been |
| | installed regarding mailing and other |
| | transport of media or material? |
| | 5. Are procedures in place for proper |
| | labeling of sensitive material? |
| | 6. Are object reuse and data remanence |
| | being addressed and proper associated |
| | sanitizing procedures implemented? |
| | 7. Are monitored procedures in place for |
| | disposal of media? |
| | 8. Are proper procedures in place for |
| | disposal and/or shredding of printed |
| | material? |
| XVII. System | Hardware Maintenance |
| Maintenance | 1. Are procedures in place for |
| | monitoring and, if required, escorting |
| | individuals who perform system |
| | hardware maintenance? |
| | 2. Are controls in place on who is |
| | permitted to perform hardware |
| | maintenance? |
| | 3. Are control procedures in place for |
| | restricting access of hardware |
| | maintenance personnel to information |
| | systems? |
| | 4. Are procedures in place for |
| | authorizing hardware changes? |
| | 5. Are procedures in place to conduct |
| | impact analyses of hardware changes? |
| | 6. Are test policies and procedures in |
| | place for application to hardware |
| | changes? |
| | 7. Are policies and procedures in place |
| | to notify users and other relevant |
| | personnel of hardware changes? |
| | 8. Are hardware-related security controls |
| | set to the most secure settings by |
| | default? |
| | 9. Is hardware version control in place? |
| | 10. Are the procedures in place to modify |
| | business continuity/disaster recovery |
| | plans as a result of hardware changes? |
| | Software Maintenance |
| | 1. Are procedures in place for |
| | monitoring and, if required, escorting |
| | individuals who perform system |
| | software maintenance? |
| | 2. Are controls in place on who is |
| | permitted to perform software |
| | maintenance? |
| | 3. Are control procedures in place for |
| | restricting access of software |
| | maintenance personnel to information |
| | systems? |
| | 4. Are procedures in place for |
| | authorizing software changes? |
| | 5. Are procedures in place to conduct |
| | impact analyses of software changes? |
| | 6. Are test policies and procedures in |
| | place for application to software |
| | changes? |
| | 7. Are policies and procedures in place |
| | to notify users and other relevant |
| | personnel of software changes? |
| | 8. Are software-related security controls |
| | set to the most secure settings by |
| | default? |
| | 9. Is software version control in place? |
| | 10. Are operating system controls in place |
| | to prevent bypassing of application |
| | controls? |
| | 11. Are software components approved, |
| | tested, and put under version control |
| | before installation? |
| | 12. Is software in the organization |
| | monitored to ensure unlicensed and |
| | unauthorized software is not being |
| | used? |
| | 13. Is the information system monitored |
| | and audited to ensure that all required |
| | software patches have been |
| | implemented? |
| | 14. Are the procedures in place to modify |
| | business continuity/disaster recovery |
| | plans as a result of software changes? |
| XVIII. | Hardware Documentation |
| Documentation | 1. Does the organization have a |
| | hardware documentation policy? |
| | 2. Does the organization have up-to-date |
| | vendor-provided documentation? |
| | 3. Does the organization have up-to-date |
| | documentation for internally- |
| | developed hardware? |
| | 4. Does the organization have schematics |
| | and diagrams for hardware systems? |
| | 5. Does the organization have |
| | documented hardware testing |
| | procedures? |
| | 6. Does the organization have hardware |
| | users' manuals? |
| | 7. Does the organization have |
| | documented hardware backup |
| | procedures? |
| | Software Documentation |
| | 1. Does the organization have a software |
| | documentation policy? |
| | 2. Does the organization have up-to-date |
| | vendor-provided software |
| | documentation? |
| | 3. Does the organization have up-to-date |
| | documentation for internally- |
| | developed software? |
| | 4. Does the organization have schematics |
| | and diagrams for software systems? |
| | 5. Does the organization have |
| | documented software testing |
| | procedures? |
| | 6. Does the organization have software |
| | users' manuals? |
| | 7. Does the organization have |
| | documented software backup |
| | procedures? |

¹Refer top Appendix I: Section C-“HTTP Tunneling” for more details on managing this threat.
²Recommendations for handling Malicious Code are addressed in Appendix IIX.
³As defined by the DHS, CERT, or Vendor.
⁴For more details refer to the Appendix I.
⁵For more details on XL security please refer to the Appendix.
⁶Recommendations for handing DDoS intrusions are covered in Appendix VI.
⁷As it is much more difficult to address security once deployment and implementation have occurred, security should be considered from the initial planning stage. Organizations are more likely to make decisions about configuring computers appropriately and consistently when they develop and use a detailed, well-designed deployment plan thataddresses security. Establishing such a plan guides organizations in making the inevitable tradeoff decisions between usability, performance, and risk. Organizations often fail to take into consideration the human resource requirements for both deployment and operational phases of the Web server and supporting infrastructure. Organizations shouldaddress the following points in a deployment plan:
Types of personnel required (e.g., system and Web administrators, Webmaster, network administrators, information systems security officers [ISSO])
Skills and training required by assigned personnel
Individual (level of effort required of specific personnel types) and collective manpower (overall level of effort) requirements.
⁸Appropriate management practices are critical to operating and maintaining a secure Web server. Security practices entail the identification of an organization's information system assets and the development, documentation, and implementation of policies, standards, procedures, and guidelines that ensure confidentiality, integrity, and availability of information system resources.
⁹Refer to Appendix.
¹⁰For complete and detailed evidentiary guidelines refer to the Appendix.

I claim as my invention:

1. A method for assessing an organization's e-security processes, comprising:
defining the e-security best practice concepts;
embodying the e-security best practice concepts in the CCLIF methodology;
defining the e-security CCLIF methodology appraisal method;
using the e-security CCLIF methodology for process improvement; and,
using the e-security CCLIF methodology to gain assurance.

2. The method according to claim 1, which comprises the steps of establishing the characteristics of e-security Security Objectives that embody the best principles of the practices of e-security.

3. The method according to claim 1, which comprises the steps of specifying e-security Security Objectives that embody the best principles of the practices of e-security.

4. The method according to claim 1, which comprises the steps of establishing the characteristics of Layers of Electronic Security that comprise Security Objectives.

5. The method according to claim 1, wherein:
the Security Objectives are categorized under Layers of Electronic Security headings, and,
the Layers of Electronic Security serve to organize related Security Objectives under a specific area.

6. The method according to claim 1, which organizes the Layers of Electronic Security and corresponding Security Objectives under domain-specific headings, such as “Risk Management, Policy Management, and Cyber-Intelligence.”

7. The method according to claim 1, which comprises a description of each Security Objective.

8. The method according to claim 1, which establishes the relationship between Layers of Electronic Security and Security Objectives

9. The method according to claim 1, which describes the e-security CCLIF methodology architecture.

10. The method according to claim 1, which describes the means to obtain continuity through the application of knowledge acquired in previous efforts.

11. The method according to claim 1, which describes the means to obtain repeatability of CCLIF process results.

12. The method according to claim 1, which comprises the phases of a CCLIF methodology appraisal method for use in appraising e-security organizations and practitioners

13. The method according to claim 1, which comprises the step of establishing the context of an e-security CCLIF methodology appraisal.

14. The method according to claim 1, which comprises the step of applying the e-security CCLIF methodology to an appraisal.

15. The method according to claim 1, which comprises the step of using the Security Objectives in an appraisal.

16. The method according to claim 1, which comprises the steps for organizations to evaluate their e-security practice.

17. The method according to claim 1, which comprises the steps for organizations to define improvements for their e-security practices.

18. The method according to claim 1, which comprises the steps for organizations to evaluate their e-security practices for adherence to accepted methods.

19. The method according to claim 1, which comprises the steps for customers to evaluate a provider's e-security practices.

20. The method according to claim 1, which comprises the step of determining which Layers of Electronic Security apply to an e-security organization.

21. The method according to claim 1, which comprises the step of establishing how to interpret the applicable Layers of Electronic Security.

22. The method according to claim 1, which comprises the steps of determining the level of e-security assurance.

23. The method according to claim 1, which comprises the use of process evidence to evaluate the level of an organization's e-security assurance.

24. A method for assigning roles associated with an organization's e-security processes, comprising:
defining e-security-related roles;
defining responsibilities associated with e-security roles;
associating the e-security roles with the CCLIF methodology; and,
associating the e-security roles with the CCLIF methodology appraisal method.

25. The method according to claim 24, which comprises the steps of establishing that fundamental e-security roles can be mapped onto Security Objectives.

26. The method according to claim 24, which comprises the steps of mapping e-security responsibilities onto Security Objectives.

27. The method according to claim 24, which comprises the steps of establishing the role characteristics associated with the CCLIF methodology.

28. The method according to claim 24, which comprises the steps of defining roles in the e-security CCLIF methodology for process improvement.

29. The method according to claim 24, which comprises the steps of defining roles in the e-security CCLIF methodology to gain assurance.

30. A method of incorporating supporting detailed, subprocesses in the CCLIF Process addressing:
firewalls;
active content filtering;
HTTP tunneling
intrusion detection;
encryption,
802.11;
GPS;
digital forensics;
XML security;
virus scanning;
rootkit mitigation;
rootkit remediation;
SQL database security;
Oracle database security;
domain name hijacking;
UNIX security;
LINUX security;
DDoS issues;
DNS processes;
malicious code;
BGP processes;
identity theft; and,
intrusion detection.
